(19) United States
(12) Patent Application Publication
(10) Pub. No.: US 2016/0042665 A1
(43) Pub. Date: Feb. 11, 2016

(54) Dog Agility Board Game

(71) Applicant: Annette Cioffi-Parker, Brick, NJ (US)

(72) Inventor: Annette Cioffi-Parker, Brick, NJ (US)

(21) Appl. No.: 14/453,151

(22) Filed: Aug. 6, 2014

(51) Int. Cl. G09B 19/22; A63F 3/04

(52) U.S. Cl. CPC G09B 19/22; A63F 3/04

(57) ABSTRACT

An educational board game relating to breeds of dogs and dog agility competitions includes outer sidewalk and inner course ring paths along which a plurality of player position markers are moved along a game board, during which—in accordance with the instructions of play—Fact Statements about breeds of dogs are read aloud to all players and True-False Questions about dog agility competitions are answered depending on positional landings of the markers upon a player's throw of a die or spin of a pointer.

### CROSS-REFERENCE TO RELATED APPLICATIONS

None.

### STATEMENT REGARDING FEDERALLY SPONSORED RESEARCH OR DEVELOPMENT

None.

### REFERENCE TO A MICROFICHE APPENDIX

None.

### BACKGROUND OF THE INVENTION

1. Field of the Invention

This invention relates to board games, in general, and to one providing an education for young children both about breeds of dogs and about the sport of dog agility competition, in particular.

2. Description of the Related Art

As will be appreciated, board games are widely known in the panoply of games available to both young and old. In fact, board games have always been a part of human history, continuing to thrive through present day gravitations towards video and computer screens for entertainment purposes. While many board games fulfill their particular objectives and requirements, by and large, they fail to serve as a teaching tool for elementary school age children. Testing has shown, however, that such skills as “counting”, “pattern” and “shape” recognition can be enhanced through the use of board games in improving a child's ability to focus and to increase his/her attention span by encouraging a completion of a game. Board games have also been recognized as promoting imagination and mental stimulation, and in teaching the lessons of winning and losing, sharing and communicating to others. And, obviously, board games can also encourage family time in enhancing togetherness.

At the same time, it has become more and more recognized that “dog agility” is a fast growing sport—and that people of all ages love dogs. In fact, the Westminster Kennel Club has recently introduced “agility competition” as part of its well-received and outstanding annual dog show.

### OBJECTS OF THE PRESENT INVENTION

It is an object of the present invention, therefore, to provide an education board game teaching the players both about dog breeds and dog agility competitions at the same time.

It is an object of the present invention, also, to promote the educational aspect of the game by offering interesting facts about the sport of dog agility, and about dogs in general, throughout the play of the game.

It is another object of the invention to offer trivia questions based upon these facts as part of the game play, in testing a player's memory and knowledge over a wide age range.

It is yet a further object of the invention to promote the sport of dog agility, while facilitating both educational and therapeutic skills throughout the game play—especially in serving as an introduction to future enthusiasts, while also increasing knowledge to those already familiar with the sport.

In these respects, the dog agility board game according to the present invention substantially departs from the conventional concepts and designs of prior board games—and in so doing, provides an apparatus primarily developed for the purpose of play by a plurality of players until a winner is declared—but also to be continued until all players complete the assigned instructions of the game in reaching second, third, fourth, etc. place finishes.

### SUMMARY OF THE INVENTION

As will become clear from the following description, the dog agility board game is targeted for a plurality of children players, ages 7 and up. Simply stated, the game consists of a board containing spaces on a sidewalk path perimeter, “Action Board Cards” [“Board Cards”] directing or instructing a player on things to do as part of their turn and “Agility Obstacle Cards” [“Obstacle Cards”] containing educational fact information, and true or false questions about dog breeds and dog agility competitions. In play, a goal of the game is to collect a prescribed number of Obstacle Cards that are needed to complete a specific agility course run. This is done first by the tossing of a die in moving a playing piece around the game board, collecting Obstacle Cards on the way. Once the Obstacle Cards are collected to match a specific course run, the player enters into a center agility ring; there, the player begins to move through the given course, defined by the positioning of a number of agility obstacle pieces in an attempt to reach the Finish Line. This latter movement is controlled through the use of a spinner.

The playing pieces in a preferred embodiment of the invention would consist of replicas of various breeds of dogs which each player chooses from. The agility obstacle pieces defining the run consist of replicas of jumps (broad, single, double and panel), teeters, A-Frames, tunnels, tires, chutes, and dog walks—along with a weave pole—of a type, for example, encountered at the Westminster Show. The Board Cards contain various directions and instructions which players follow in the course of the game (e.g. move ahead, move back, lose a turn, etc.). The “Obstacle Cards”include Factual Statements about the breeds of the various dog replica playing pieces, and Questions about dog agility competition procedures. As each player completes the course in reaching the finish line, he/she earns a qualifying ribbon based upon the position of finish—the ribbons also serving as actual award replicas in the playing of the game.

As such, those skilled in the art will appreciate, this described concept may readily be used as a basis for the designing of other structures, methods and systems for carrying out the several objectives of the present invention, or others like it. It is important, therefore, that the detailed description set forth below be regarded as including such equivalent constructions in so far as they do not depart from the spirit and scope of the teachings herein, even though the layouts, cards, and operations of this board game be modified. Thus, the dog agility game may be played in numbers beyond the 2-5 players typically envisioned for young children play in the preferred embodiment of the invention, and for the teaching about mixed breeds, as well.

### BRIEF DESCRIPTION OF THE DRAWINGS

These and other features of the invention will be more clearly understood from a consideration of the following description, taken in connection with the accompanying Drawings in which:

FIG. 1 is a schematic plan view of the layout of the game board in accordance with the invention;

FIG. 2 is a schematic perspective view of the die number generator utilized in the play of the game;

FIG. 3 is a schematic plan view of the spinner number generator utilized;

FIG. 4A-4D are perspective views of the front side of some Board Cards which the players are required to follow in playing the dog agility board game of the invention;

FIG. 5 is a schematic perspective view of the front side of some Obstacle Cards, each showing the name and picture of a given agility competition obstacle;

FIG. 6 is a schematic perspective view of the back side of some Obstacle Cards, each containing fact statements pertaining to breeds of dogs along with true-false questions regarding dog agility competitions as part of the educational information program of the game;

FIGS. 7A-7L are schematic perspective views of some agility competition obstacles utilized in the game's play;

FIG. 8 is a pictorial view of a dog breed replica corresponding to a player of the game; and

FIG. 9 is a schematic perspective view of the qualifying ribbon award earned by the players completing the course run.

Although not shown as such, it will be understood that each player's playing piece consists of a replica of a different individual breed of dog and that each ribbon awarded for a first, second, third, fourth, etc. place finish in the play of the game can be of any shape, cutout, design or color.

As will be understood from the following description, the goal in the play of the dog agility board game is to be the first dog to reach the finish line.

### DETAILED DESCRIPTION OF THE INVENTION

With reference now to the Drawings, the dog agility game of the invention consists of a game board 10, a plurality of individual dog breed replica playing pieces, a plurality of agility competition obstacle replica pieces 14, a plurality of Action Board Cards 16, a plurality of educational information Obstacle Cards 18, a die 12 and a spinner 20.

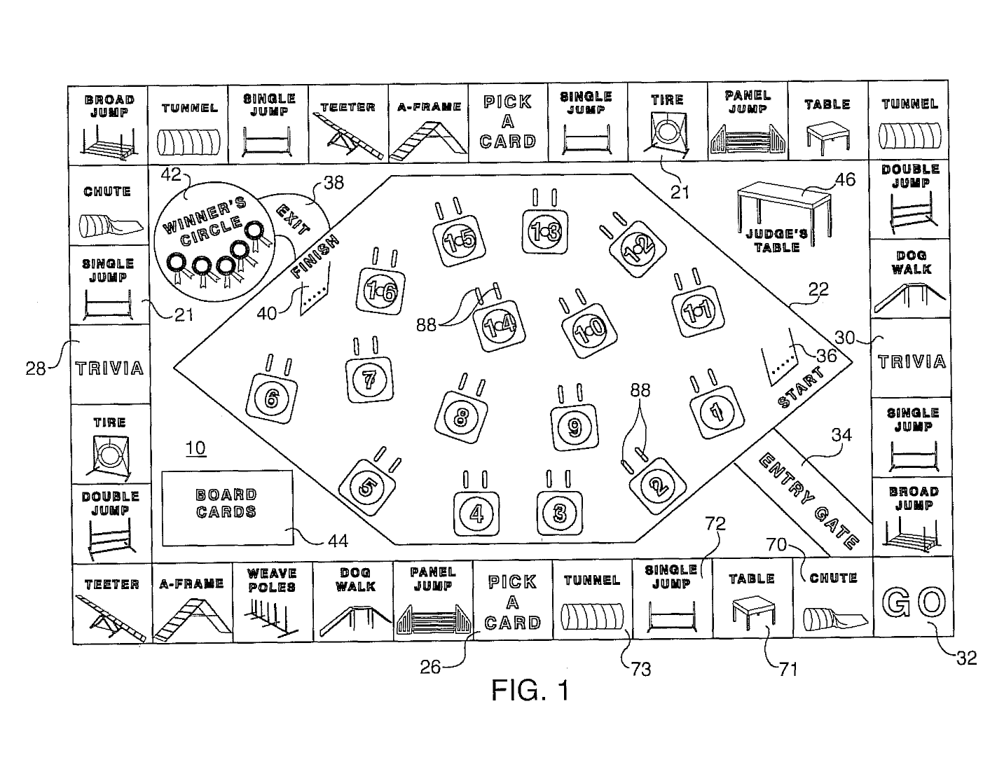

As more particularly shown in FIG. 1, the game board 10 consists of a plurality of outer playing spaces 21 arranged in a sidewalk path surrounding an inner course ring path 22. In a preferred rectangular-shaped embodiment, the game board 10 is divided into eleven sidewalk playing spaces on each of the top and bottom, and five sidewalk playing spaces on each side—yielding thirty two playing spaces in number. Twenty seven of the playing spaces include an illustration of an obstacle found in dog agility competitions along with its name, placed randomly around the board. Two playing spaces 24, 26 placed in the center of the longer sides are labeled with the words “pick-a-card”—positioned five spaces to the left and five spaces to the right of the corners of the longer sides of the board 10. Two playing spaces 28, 30 are labeled with the word “trivia”, similarly centered in the center of the shorter sides of the board—three spaces from both the top and the bottom. One playing space 32 is labeled with the word “GO” at the bottom right corner of the board. A first path 34 labeled “ENTRY GATE” extends inwardly from the right-corner “GO” space 32 through a “START LINE” depiction 36 towards the course ring 22. A second path 38 labeled “EXIT” extends outwardly from the course ring 22 through a “FINISH LINE” illustration 40 to the “Winners Circle” 42. As illustrated, the “ENTRY GATE” path 34 is of greater length than the “EXIT” path 38 as in most dog competitions. A space labeled “BOARD CARDS” 44 is located at the bottom left side of the game board 10, with a depiction of a “JUDGE′S TABLE” 46 located on the upper right side of the board. In the preferred construction of the game board 10, the sidewalk path spaces 21 are of 2.5″ squares, and the board 10 measures 28″ by 17.5″. As illustrated in FIG. 1, the sidewalk spaces 21 include the following 27 instances of illustrated dog agility obstacles: broad jumps—2; tires—2; tables—2; dog walks—2; teeters—2; A-frames—2; double jumps—2; chutes—2; tunnels—3; single jumps—5; weave pole—1; panel jump—2.

As will be appreciated by those skilled in the art, however, the size of the board, the size of the outer sidewalk spaces, the number of the spaces, their placements, their names, the obstacles illustrated in the spaces, and the obstacle namings may be modified or altered as desired.

The inner course ring 22 in the center of the game board 10 is in the shape of a hexagon, inside of which are 16 spaces printed with traffic-replica cones numbered 1-16, with the “No. 1” cone space 50 adjacent to a START LINE 36 and with the “No. 16” cone space 52 adjacent to a FINISH LINE 40. Labeled and numbered in order to promote a continuous path from the “START LINE” 36 to the FINISH LINE 40, the “No. 8” cone space 54 includes a depiction of a “Weave Pole” obstacle. Grooves 88 are cut into each of the 16 cone spaces to allow individual ones of 16 agility obstacle replica pieces to fit and be held there in a 3-D format. In the preferred embodiment of the invention, the top and bottom sides of the hexagonal course ring 22 are of 7.5″ length, while the additional four sides measure 8.75″ in length.

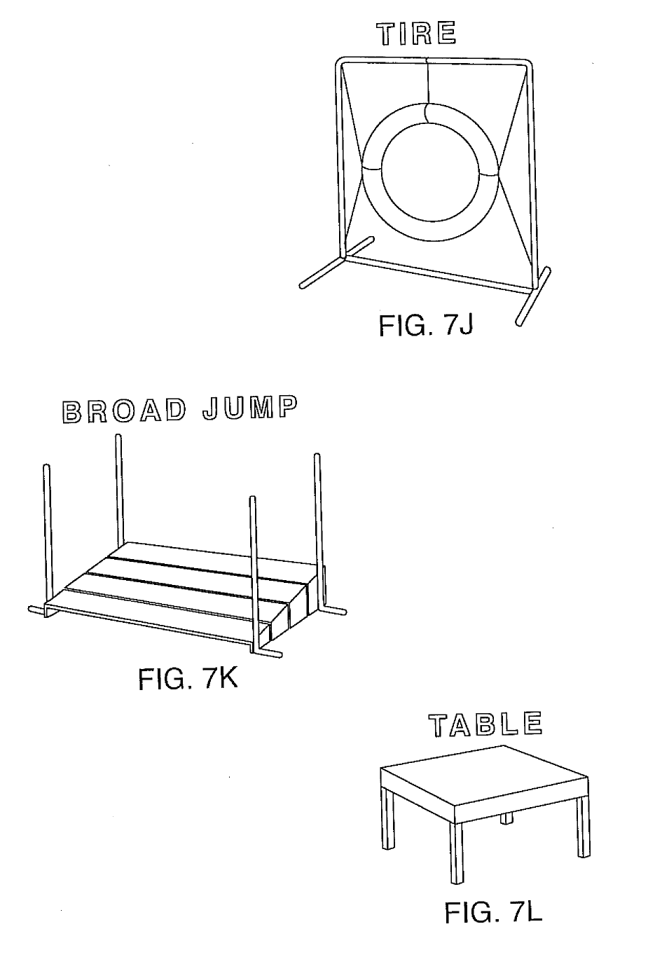

The dog replica playing pieces utilized in the dog agility game (as in FIG. 8) include 8 plastic or metal replicas of breeds of dogs that the players can choose from. Selected small enough so as to fit on the spaces 21 in the sidewalk paths of the board 10 and on the 16 cone spaces of the course ring 22, the playing piece replicas may be of such Breeds as a) Jack Russell Terrier, b) Toy Fox Terrier, c) Labrador Retriever, d) Australian Shepherd, e) Border Collie, f) Doberman Pincher, g) Dachshund, and h) German Shepherd. Such playing piece replicas are also to be small enough to fit on the cone spaces of the course ring 22, while allowing room for the 16 agility obstacle replica pieces to be inserted in the grooves cut therein.

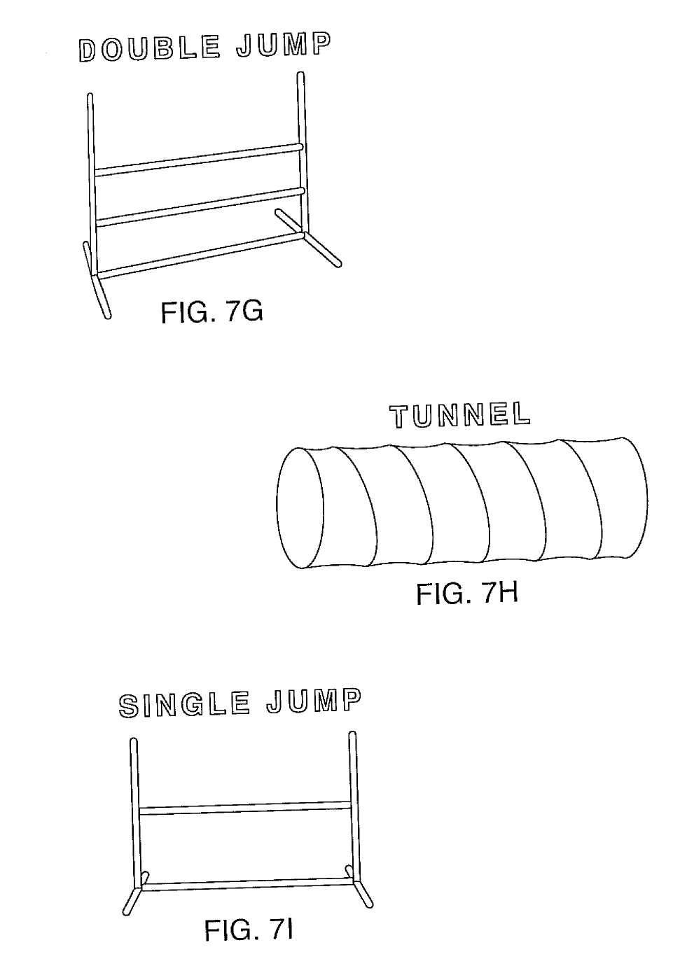

In similar manner, the agility obstacle replica pieces employed (as in FIG. 7) are made from plastic or metal, and are small enough to be placed individually onto the 16 cone spaces while leaving room for the dog replica playing pieces to be fit on as well. To accomplish this, each obstacle replica piece is constructed with clips 90 on its bottom, to fit into the grooves 88 cut in the cone spaces, with the grooves and placements of clips being uniform to allow each obstacle to fit appropriately into each and every cone space denoted by the 16 cone locations. In thus allowing different courses to be set up as described below, the agility obstacle replica pieces for the playing of the game include 2—broad jumps, 2—tires, 2—tables, 2—dog walks, 2—teeters, 2—A-Frames, 2—double jumps, 2—panel jumps, 2—chutes, 3—tunnels, 5—single jumps, and 1—weave pole totalling 27 obstacle pieces.

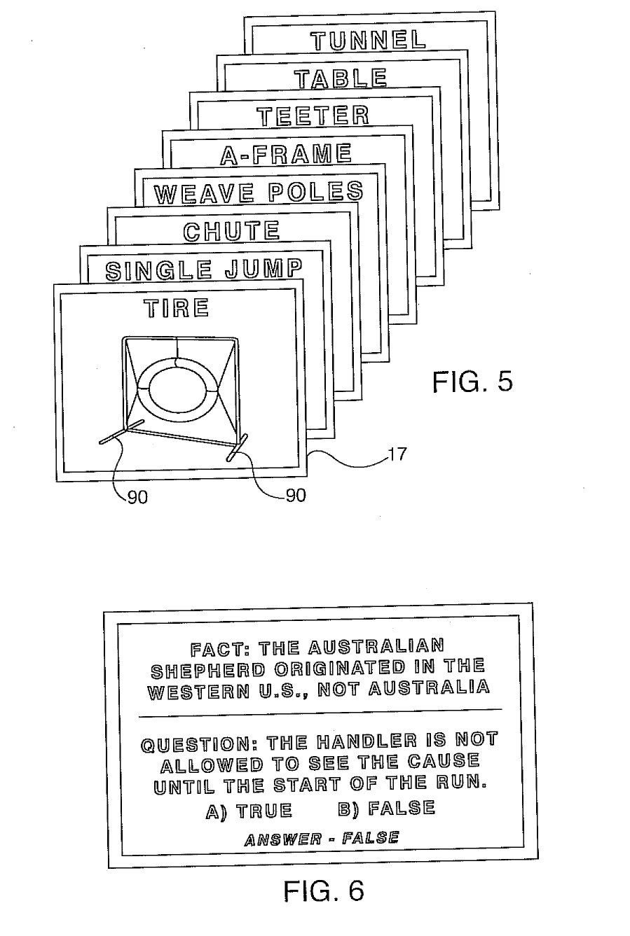

In the preferred embodiment of the invention, 25 Action Board Cards (“Board Cards”) 16 are employed, along with 135 Agility Obstacle/educational-fact-information cards (“Obstacle Cards”) 18. The 25 Board Cards are stacked front side “down” at the “Board Cards” space 44 and contain on the front side one of a series of directions/instructions which each player is required to follow according to the Rules of the Game. Some of these directions/instructions on the 25 cards might include: a) take one obstacle card from player on right, b) proceed to the closest tunnel space, c) roll again, d) give one Obstacle Card to player on your left, e) lose one turn, f) move back 2 spaces, etc., as in FIGS. 4A-4D.

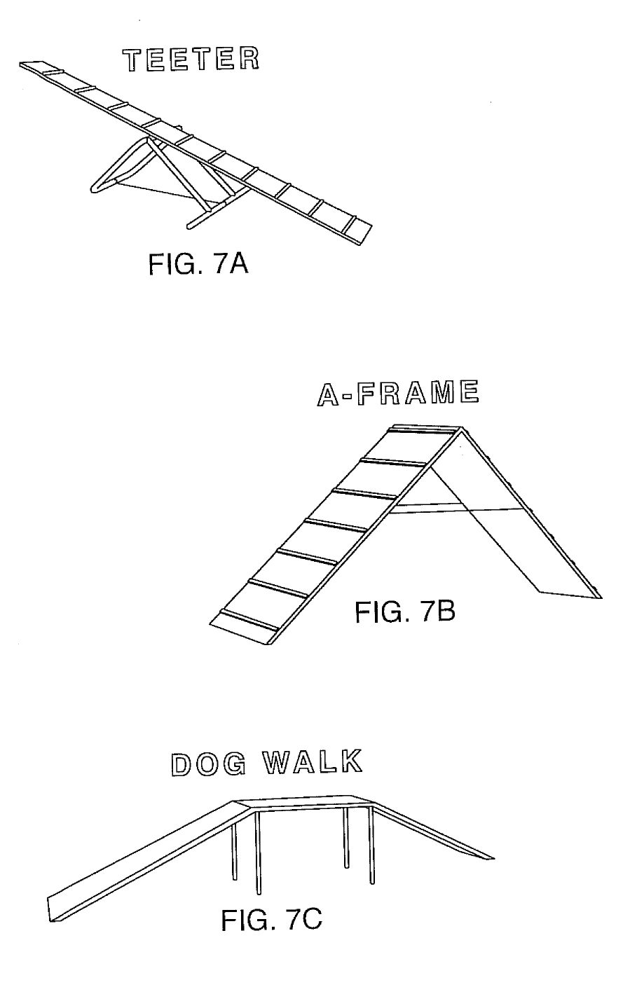

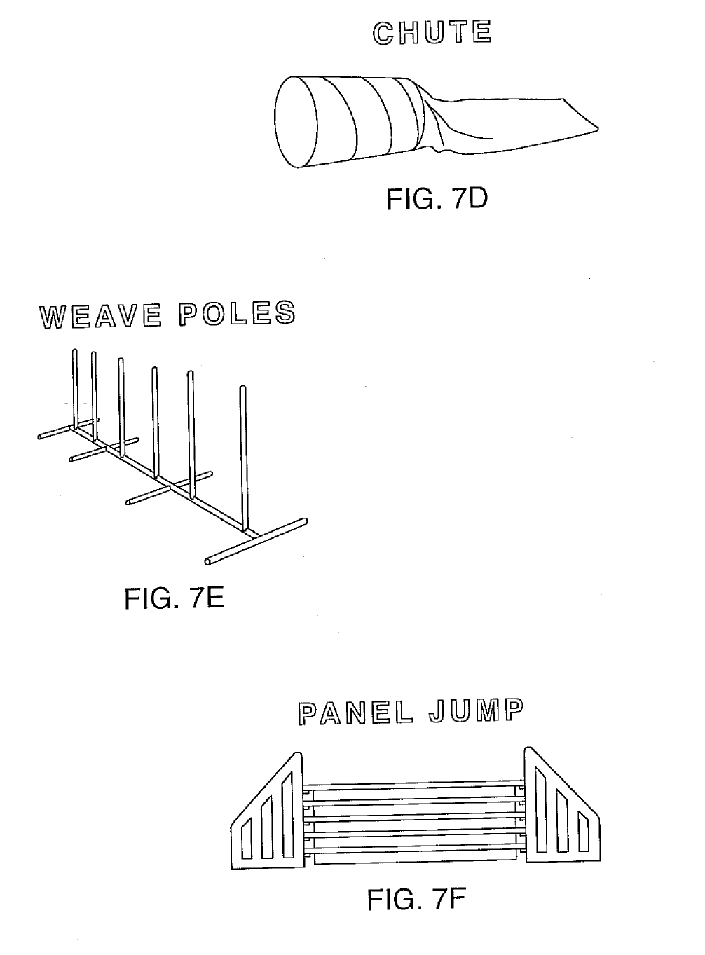

The 135 Obstacle Cards 18 include both the name and depiction of a given obstacle on the front side (FIG. 5); on the back side (FIG. 6), they contain a fact statement pertaining to the various dog breeds represented by the playing piece replicas, along with true-false questions as to agility competitions and characteristics. For example, the front side of a card might include the name and depiction of the Tire obstacle while the back side might include “Fact: The Australian Shepherd Originated In The Western U.S. Not Australia”; along with the “Question: The Handler Is Not Allowed To See the Course Until The Start Of The Run—a) True b) False”, (along with its correct Answer, “false”). A second card showing a Single Jump obstacle depiction and name on the front side might include on its back side: “Fact: The German Shepherd Is Used For Search And Rescue” and the “Question: The Open Tunnel, Weave Pole, A-Frame And Teeter Are Bi-Directional—a) True b) False” (with its correct Answer). A third card might show a Dog-Walk obstacle depiction and name on the front side, and on its back side: “Fact: One Of The Fastest Agility Dogs Is Considered To Be The Jack Russell Terrier” and the “Question: A Handler May Use Body Control And Movement In Directing The Dog Through The Run, But Not Voice—a) True b) False”, (together with the correct Answer). As will be understood, the “Facts” on each Obstacle Card relate to the dog breed replica pieces provided, while the “Questions” relate to dog agility competitions, in general, or to the factual statements pertinent to the dog breed in question.

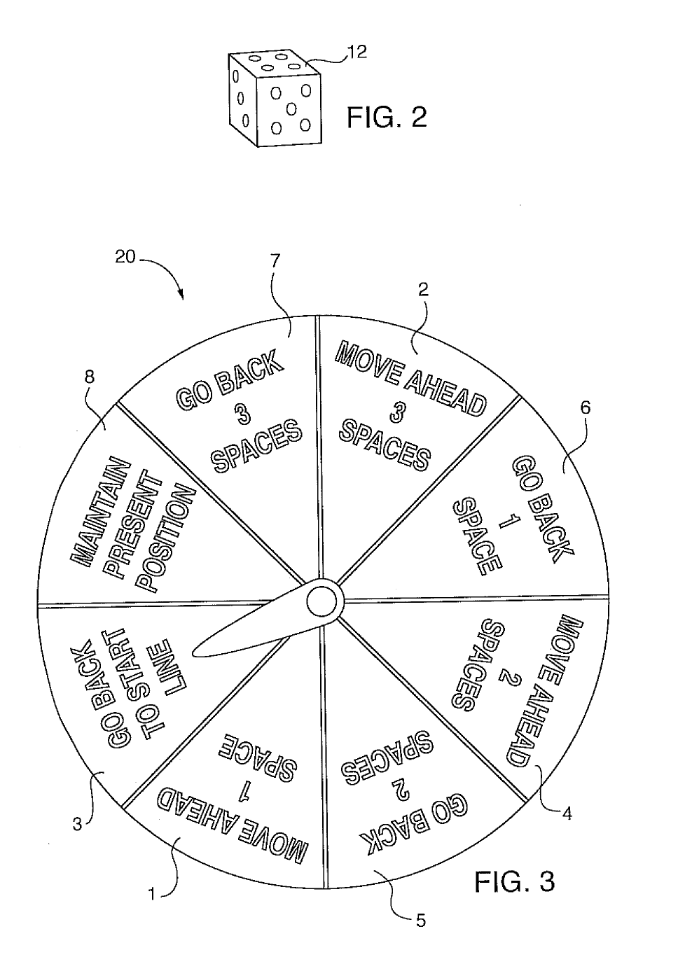

As shown in FIG. 2, the die 12 utilized in the game is that of a normal 6 sided die.

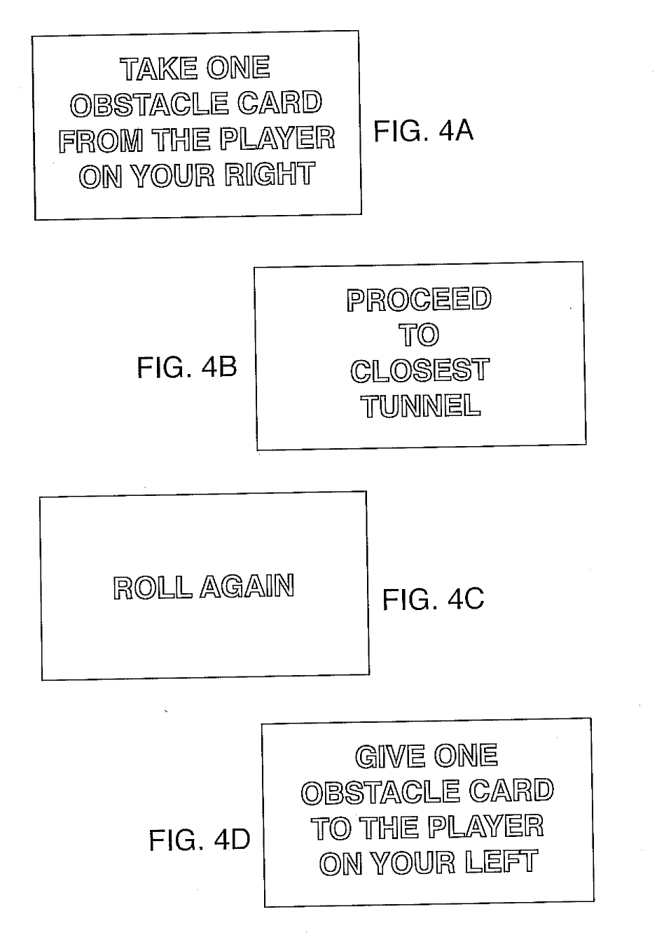

As shown in FIG. 3, the spinner 20 utilized consists of a circular card, preferably of a cardboard type material with a plastic pointer 60 in its center. The circle is divided into 8 pie-shape sections, each having a direction or instruction to be followed, such as: 1) Move Ahead 1 Space, 2) Move Ahead 3 Spaces, 3) Go Back To Start Line, 4) Move Ahead 2 Spaces, 5) Go Back 2 Spaces, 6) Go Back 1 Space, 7) Go Back 3 Spaces, 8) Maintain Present Position.

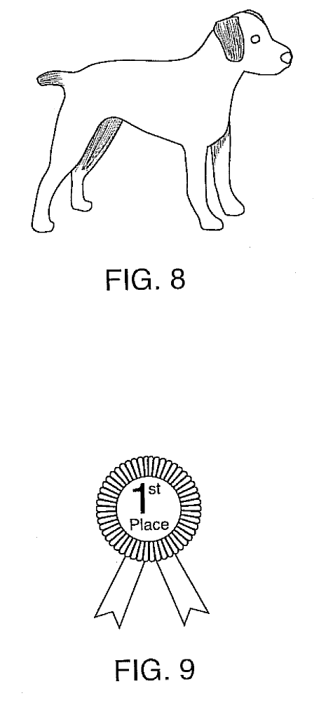

Winner Ribbon Awards earned in the playing of the game are of 5 different colored plastic ribbons overwritten as 1st Place (Blue), 2nd Place (Red), 3rd Place (Yellow), 4th Place (Green) and 5th Place (Purple) (FIG. 9, 1st Place).

Some agility competition obstacle replica pieces to be inserted into the cone spaces of the course ring 22 are shown in FIGS. 7A-7L.

Further details and specifics of the dog agility game of the invention as are follows:

OBJECT OF THE GAME: The object of the game is to be the first player to reach the Winner's Circle 42 on the game board 10 and be awarded the 1st Place Blue Ribbon.

PLAYERS: 2 to 5 players ages 7 and up.

THE GAME: The game itself will come in a box.

SET UP AND HOW TO PLAY: Each player chooses a dog breed replica playing piece and places it on the GO space 32. The 25 Board Cards are shuffled and placed on the Board Cards space 44 front side “down”. The 135 Obstacle Cards are sorted according to the obstacle depictions illustrated on their front sides. For the 5-player game according to this preferred embodiment of the invention, 5 Obstacle Cards are stacked for the weave pole obstacle, 30 Obstacle Cards are stacked for the single jump obstacle, and 10 Obstacle Cards are stacked for each of the remaining 10 obstacle depictions. Each player in turn then rolls the die, and the highest rolled number player builds the inner course ring 22 using the weave pole obstacle replica piece and whatever 15 other selected obstacle replica pieces he/she desires. The weave pole obstacle replica piece is placed in cone space No. 8 of the hexagonal center, and the other 15 obstacle replica pieces are randomly placed in the other cone spaces. Each of the Obstacle Cards stacks are arranged front side “up”.

While the object of the game is to be the first player to reach the Winner's Circle 42, a player must first get to the Entry Gate path 34, successfully traverse the 16 cone spaces of the inner course ring 22, and pass through the Exit path 38. In order to arrive at the Entry Gate path 34, and START LINE 36, however, the player must first accumulate the number of Obstacle Cards whose depictions correspond to the obstacle replica pieces set up in the cone spaces of course ring 22. Thus, if the course ring includes 2 “table obstacle replica pieces”, 2 “tunnel obstacle replica pieces” and 1 “A-frame obstacle replica piece” amongst others, that player must accumulate Obstacle Cards corresponding to these 5 obstacles in the play of the game as well as to the remaining 11 obstacle replica pieces set up in establishing the course ring configuration.

The method of play and the educational aspect of the game are established in the following manner—assuming the obstacle replica piece set up for the ring 22 includes 2 tables, 2 dog walks, 2 tires, 1 A-frame, 2 teeters, 5 single jumps, 1 broad jump and 1 weave pole (the words “replica piece(s)” and “breed replica playing piece(s)” being hereafter purposely omitted for the sake of simplicity).

The player to the right of the high number roller begins by throwing the die in moving his/her dog around the board in a clockwise fashion, followed by the next player to the left. When landing on an obstacle space on the board 10, the player selects a correspondingly front or top-side depicted Obstacle Card from the top of its respective stack and reads aloud to the other players the dog breed fact statement printed on its back bottom underside. The player then collects the Obstacle Card and places it in his/her respective pile—even if the Obstacle Card does not correspond to any of the obstacles placed in the course ring cone spaces. In play, for example, if the first player to roll the die throws a “1” to move its playing piece to the “chute” board space 70 of the game board 10, the player reads aloud the fact statement about dog breeds on the top Obstacle Card with a “chute” depiction and retains the card. Should the next player to the left then throw a “2”, he or she would move their playing piece to board space 71 and read the fact statement on the top Obstacle Card with a “table” depiction, corresponding to board space 71, adding the card to his/her own pile. The same transpires with the next player to the left, rolling a “3” allows the player to move to board space 72 and to collect from the “single jump” Obstacle Cards, reading the Card's dog breed fact statement to the group, placing that card in his/her pile. The next player, rolling a “4”, moves to board space 73, collects a “tunnel” Obstacle Card, reading its statement aloud as to facts concerning a dog breed, and retains that card. Play then continues around the board 10, quite possibly for many times, until each player has collected 16 Obstacle Cards which match the 16 obstacles originally placed by the high numbered die rolling player in the ring 22. This allows the players to then proceed to the ENTRY GARE path 34 in turn.

Should a player land on a space occupied by another player by rolling the die, the player must move back one space, pick an Obstacle Card that matches that obstacle illustrated on the board space there, read the fact statement about dog breeds on that card, and retain the card for hither use. If a player lands on a “pick-a-card space” (as at 24 or 26), the player would select a top Board Card from space 44 and follow its front side instructions/directions such as “lose a turn” or “throw again”—or such other directions or instructions as “give one Obstacle Card of your choice to the player on your right”, “collect one Obstacle Card from any player you choose”, “return to the bottom of the Obstacle Card stack an Obstacle Card that corresponds to one of the obstacles in the course ring 22”, etc. Should a player land on either of the “trivia” board spaces 28, 30, then the player on its left who proceeded him/her is to read one of the true-false questions about dog agility competitions from any one of the Obstacle Card stacks; if answered correctly, the answering player may choose an Obstacle Card of any choice from any stack. If that player answers incorrectly, on the other hand, nothing happens and play just continues. Play continues in this manner around the board, with “facts” about breeds of dogs being read continuously, and questions about dog agility competitions being asked when a player rolls the die to land on one of the two “trivia” spaces. As each player obtains the Obstacle Cards corresponding to all the obstacles placed in the inner course ring 22 by the high number rolling die thrower, the player continues around the board until arriving at the ENTRY GATE path 34. While not having to reach the ENTRY GALE by an exact number on the die being thrown, once there that player still must wait his/her next turn to proceed along the course ring 22—this time, however, by use of the spinner 20 (FIG. 3). Each of the other players continue to use the die in progressing around the game board 10, reading dog breed statements and answering true-false questions as the case may be, until they each collect the 16 Obstacle Cards that correspond to the obstacle pieces in the inner course ring 22—before themselves proceeding to the ENTRY GATE path 34 in turn, and then simultaneously surrendering all their collected Obstacle Cards so as to make them available to the other players whose collections still might not be complete.

Once in the ENTRY GATE path 34, the spinner 20 comes into play. In accordance with the player's spin, the player then moves his/her playing piece from cone space 1 through cone space 16, moving forwards or backwards, remaining stationary, etc., as indicated by the spinner pointer 60. Play continues on for each other player until the player in the course ring 22 is able to move that number of spaces to the FINISH LINE 40 and EXIT path 38 consistent with the pointer 60 landing. If the spin should indicate a different forward movement than is needed to reach the EXIT path 38, that player does not follow such direction but has to wait for the next turn to spin again. Here, as in the progression around the board 10, only one player may occupy a given cone space in the course ring 22 at the same time, should a second player land on the same space, that second player must move back one space—making it a possibly close race to the Winner's Circle 42.

The first player to reach the Winner's Circle 42 receives the blue ribbon, the second receives the red ribbon—and the third, fourth and fifth player receive the yellow, green and purple ribbon, respectively; and the game ends.

In the play of the game, then, statements about the playing piece dog breeds are simultaneously read to each player of the game, as are the correct answers to the true-false questions describing different aspects of the dog agility competition sport itself.

While there have been described what is considered to be a preferred embodiment of the present invention, it will be readily apparent to those skilled in the art that modifications can be made without departing from the scope of the teachings herein. For example, as an adjunct to the described dog agility board game, different dog breed playing pieces can be packaged for sale together as a group, along with different agility Obstacle Card sets germane to such breeds.

In those instances, the obstacle depictions on the front or top sides of the Obstacle Cards for all packaged sets will be the same as will the true-false questions since the obstacles encountered in dog agility competitions are generally the same throughout. The Fact Statements on the Obstacle Cards, however, will confomi to the dog breed replica game pieces there packaged. In such instance, for example, a pack of Obstacles Cards for Breed playing piece replicas including a) Boxer, b) Chihuahua and c) Cocker Spaniel would include such fact statements as: “The Boxer is a bright energetic and playful breed that tends to be very good with children”; “The Chihuahua comes in a wide variety of sizes, head shapes, colors and coat lengths”; and “The Cocker Spaniel is a happy breed but often suffers with health problems with their hearts, eyes and ears, respectively”. Or separate packaged sets could be sold for such American Kennel Club groups as “Terrier Breeds”, “Toy Breeds”, “Hunting Breeds”, “Sporting Breeds”, etc., with Fact Statements appropriate to the breeds in the set. For at least such reason, therefore, and further, as different fact statements may be employed and different instructions of play accepted in use—resort should be had to the claims appended hereto for a true understanding of the scope of the invention.

I claim:

1. A dog agility board game comprising:
a game board having a first plurality of playing spaces arranged in an outer sidewalk path, and a second plurality of playing spaces arranged in an inner course ring path a leading to a “winner's circle’ play location;
a plurality of playing pieces, each representing an individual breed of dog, and each corresponding to a player of said game;
a plurality of dog agility competition obstacles;
random number generator means for regulating movement of said playing pieces along said outer sidewalk path playing spaces and said inner course ring path playing spaces;
a plurality of Board Cards, each containing a direction step of action to be taken by the players of said game;
a plurality of Obstacle Cards, each containing a fact statement pertaining to a playing piece breed of dog and a true-false question pertaining to dog agility competitions; and
a set of accepted rule instructions including a player's reading factual statements as to individual breeds of dogs upon the player's playing piece reaching individual playing spaces of said sidewalk path spaces, and answering true-false questions as to dog agility competitions in landings thereupon, accumulating individual Obstacle Cards in so doing, and in proceeding to said inner coarse ring path playing spaces leading to said “winner's circle” play location only after collecting all Obstacle Cards corresponding to dog agility competition obstacles initially established at said inner coarse ring path playing spaces at the beginning of a game's play.

2. The dog agility board game of claim 1, wherein each of said plurality of Board Cards contains a direction step of movement of a playing piece around the game board or an instruction of Obstacle Card transference between players.

3. The dog agility board game of claim 1, in which each Obstacle Card also includes the correct answer to each of said true-false questions pertaining to dog agility competitions.

4. The dog agility board game of claim 1, wherein said plurality of dog agility competition obstacles include individual ones of broad jumps, tires, tables, dog walks, teeters, A-frames, double jumps, chutes, tunnels, single jumps, panel jumps, and weave poles.

5. The dog agility board game of claim 1, wherein said random number generator means includes a six-sided die rolled in turn by each player in which the highest number rolling player initially selects individual dog agility competition obstacles established for the inner a course ring path playing of spaces at the beginning of the game.

6. The dog agility board game of claim 5, wherein said six-sided die is also rolled in turn by each player in moving the player's individual dog breed playing piece around the outer sidewalk path playing spaces in the play of the game.

7. The dog agility board game of claim 6 wherein said random number generator means also includes a pointer spun by each player in turn in moving said individual player's dog breed along the inner coarse ring path playing spaces towards said “winner's circle” play location in the play of the game.

8. The dog agility board game of claim 7, wherein each of said outer sidewalk path playing spaces and each of said inner course ring path playing spaces are sized to accept one of said dog breed playing pieces, and wherein each of said inner course ring path playing spaces is further sized to accept one of said plurality of dog agility competition obstacles in the play of the game.

9. The dog agility board game of claim 8, wherein each of said inner course ring path playing spaces is grooved to accept insertion therein of each of said individual dog agility competition obstacles selected by said highest number die rolling player at the beginning of the game.

10. The dog agility board game of claim 9, wherein one side of each of said Obstacle Cards includes a depiction of one of said dog agility competition obstacles, and an opposite side including one of said factual statements as to individual breeds of dogs, one of said true-false a questions as to dog agility competitions, and the correct answer to the true-false question included thereon.
